(19) United States
(12) Patent Application Publication
(10) Pub. No.: US 2025/0385858 A1
(43) Pub. Date: Dec. 18, 2025

(54) Router and operation method thereof

(71) Applicant: REALTEK SEMICONDUCTOR CORPORATION, Hsinchu (TW)

(72) Inventors: Xue-Bin WU, Suzhou (CN); Xiao-Dan XU, Suzhou (CN)

(21) Appl. No.: 19/238,092

(22) Filed: Jun. 13, 2025

(30) Foreign Application Priority Data
Jun. 18, 2024 (CN) 202410788249.7

(51) Int. Cl. H04L 45/02; H04L 45/122

(52) U.S. Cl. CPC H04L 45/02; H04L 45/122

(57) ABSTRACT

An operation method of a router which switches between a first network and a second network includes the following steps: advertising a packet including a network duration and a network switching period. The network duration represents a first duration for which the router continuously operates in the first network. The network switching period is substantially equal to the first duration plus a second duration for which the router continuously operates in the second network.

### BACKGROUND OF THE INVENTION

### 1. Field of the Invention

The present invention generally relates to network equipment, and more particularly, to a router and its operation method.

### 2. Description of Related Art

With the increasing popularity of the Thread network, more and more Internet of Things (IoT) devices are following the Thread network protocol. FIG. 1 shows a schematic diagram of a conventional Thread network and the link cost of each router. The Thread network 100 includes five routers 101 to 105. The router 101 is directly connected to the router 102 and the router 103, and the link costs are 2 and 1, respectively. The router 102 is directly connected to the router 101, the router 103, the router 104, and the router 105, and the link costs are 2, 1, 1, and 2, respectively. The router 103 is directly connected to the router 101, the router 102, and the router 104, and the link costs are 1, 1, and 1, respectively. The router 104 is directly connected to the router 102, the router 103, and the router 105, and the link costs are 1, 1, and 1, respectively. The router 105 is directly connected to the router 102 and the router 104, and the link costs are 2 and 1, respectively.

Based on the aforementioned link costs, a routing table can be obtained for each router. Reference is made to FIG. 2, which is a schematic diagram of the routing table of the conventional router 101. When the destination of the route is the router 102, the router 103, the router 104, and the router 105, the next-hop router is the router 101, the router 101, the router 103, and the router 103, respectively, and the routing cost is 2, 1, 2, and 3, respectively.

If the Thread network 100 has a device that supports time division multiple access (TDMA), then the device may cause interference and congestion. For example, supposing the router 103 is a device that supports TDMA, when the router 103 switches to another network (e.g., a Bluetooth network) (i.e., when the router 103 is not operating in the Thread network 100), the router 101 performs a large number of retransmission operations because the router 101 cannot receive an acknowledgment (ACK) signal from the router 103, which will occupy a large amount of network resources and cause congestion in the Thread network 100.

### SUMMARY OF THE INVENTION

In view of the issues of the prior art, an object of the present invention is to provide a router and an operation method thereof, so as to make an improvement to the prior art.

According to one aspect of the present invention, a router is provided. The router switches between a first network and a second network and includes a wireless transceiver circuit, a memory, and a control circuit. The memory is configured to store a plurality of program instructions or codes. The control circuit is coupled to the wireless transceiver circuit and the memory and is configured to execute the program instructions or codes to perform the following steps: advertising a packet that includes a network duration and a network switching period. The network duration represents a first duration for which the router continuously operates in the first network, and the network switching period is substantially equal to the first duration plus a second duration for which the router continuously operates in the second network.

According to another aspect of the present invention, a method of operating a router is provided. The router switches between a first network and a second network. The method includes the following steps: advertising a packet that includes a network duration and a network switching period. The network duration represents a first duration for which the router continuously operates in the first network, and the network switching period is substantially equal to the first duration plus a second duration for which the router continuously operates in the second network.

According to still another aspect of the present invention, a method of operating a router is provided. The method is applied to a first router and includes the following steps: receiving a packet from a second router, wherein the second router switches between a first network and a second network, and the packet includes a network duration and a network switching period; calculating, based on a reception time of the packet and the size of the packet, a start time at which the second router switches to the first network; and determining whether the second router is currently operating in the first network according to the start time, the network duration, and the network switching period.

The technical means embodied in the embodiments of the present invention can solve at least one of the problems of the prior art. Therefore, compared to the prior art, the present invention can avoid network congestion and interference.

These and other objectives of the present invention no doubt become obvious to those of ordinary skill in the art after reading the following detailed description of the preferred embodiments with reference to the various figures and drawings.

### BRIEF DESCRIPTION OF THE DRAWINGS

FIG. 1 shows a schematic diagram of a conventional Thread network and the link costs of each router.

FIG. 2 is a schematic diagram of the routing table of a conventional router.

FIG. 3 is a functional block diagram of a router according to an embodiment of the present invention.

FIG. 4A shows a schematic diagram of the link costs of the Thread network and each router according to the present invention.

FIG. 4B is a schematic diagram of the routing table according to an embodiment of the present invention.

FIG. 5 shows the waveform of the operating clock of the router according to an embodiment of the present invention.

FIG. 6 is a flowchart of the operation method of a router according to an embodiment of the present invention.

FIG. 7 is a flowchart of the operation method of a router according to another embodiment of the present invention.

FIG. 8 is a schematic diagram of a router advertising a TDMA information packet according to the present invention.

FIG. 9 is a schematic diagram of the TDMA message table according to an embodiment of the present invention.

FIGS. 10A and 10B are flowcharts of the operation method of a router according to another embodiment of the present invention.

### DETAILED DESCRIPTION OF THE EMBODIMENTS

The following description is written by referring to terms of this technical field. If any term is defined in this specification, such term should be interpreted accordingly. In addition, the connection between objects or events in the below-described embodiments can be direct or indirect provided that these embodiments are practicable under such connection. Said “indirect” means that an intermediate object or a physical space exists between the objects, or an intermediate event or a time interval exists between the events.

The disclosure herein includes a router and its operation method. On account of that some or all elements of the router could be known, the detail of such elements is omitted provided that such detail has little to do with the features of this disclosure, and that this omission nowhere dissatisfies the specification and enablement requirements. Some or all of the processes of the operation method of the router may be implemented by software and/or firmware and can be performed by the router or its equivalent. A person having ordinary skill in the art can choose components or steps equivalent to those described in this specification to carry out the present invention, which means that the scope of this invention is not limited to the embodiments in the specification.

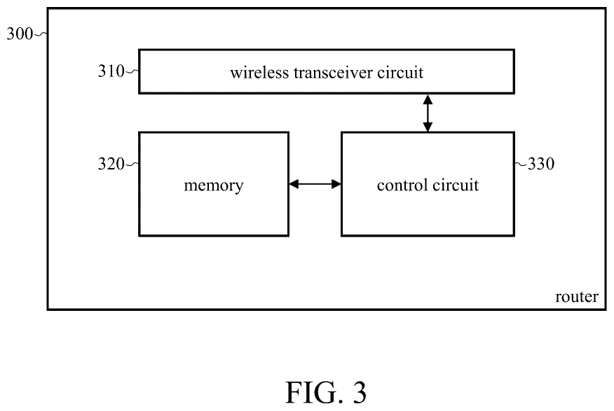

Reference is made to FIG. 3, which is a functional block diagram of a router according to an embodiment of the present invention. The router 300 includes a wireless transceiver circuit 310, a memory 320, and a control circuit 330. The driver of the wireless transceiver circuit 310 is stored in the memory 320 in the form of multiple program instructions or codes. The control circuit 330 may be a circuit or electronic component with program execution capability, such as a central processing unit (CPU), a microprocessor, a micro-processing unit, a digital signal processor, an application-specific integrated circuit (ASIC), or an equivalent circuit. The control circuit 330 controls the wireless transceiver circuit 310 by executing the program instructions or codes. The router 300 is a device that supports TDMA; more specifically, the router 300 operates in the Thread network at certain times and operates in a different network (e.g., a Bluetooth network) at other times.

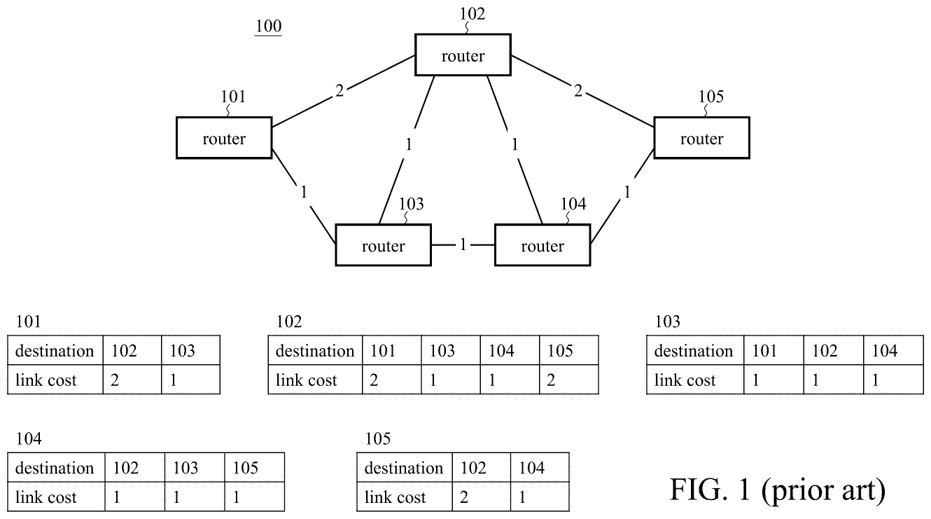

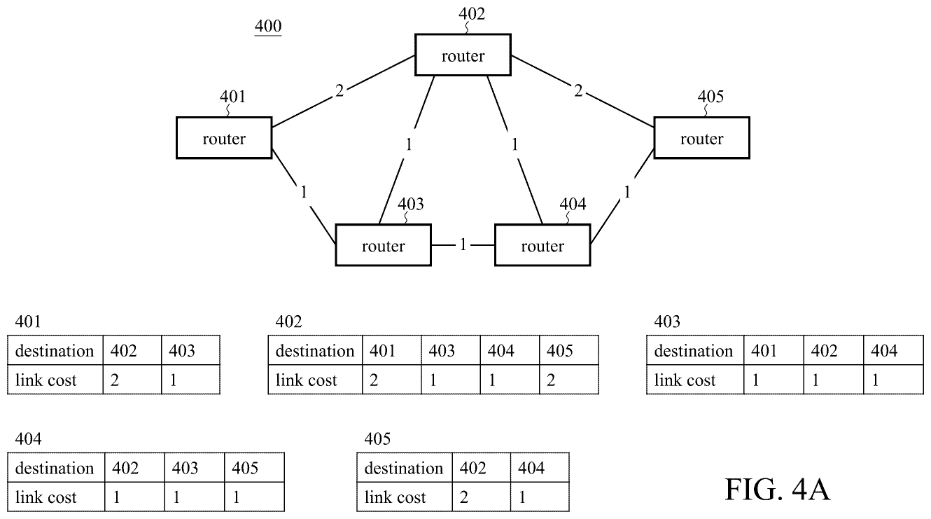

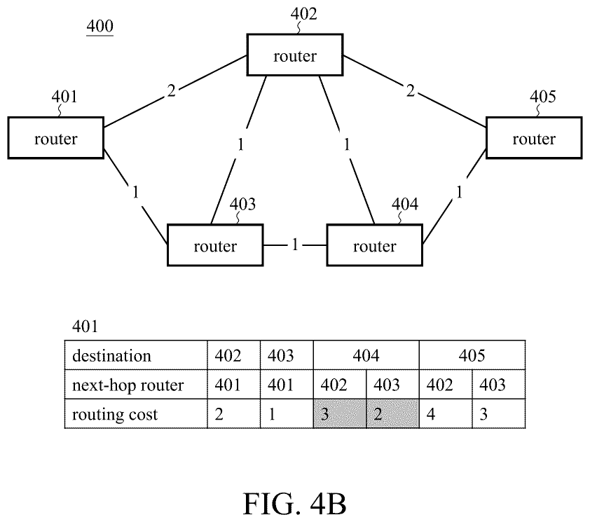

FIG. 4A shows a schematic diagram of the link costs of the Thread network and each router according to the present invention. The Thread network 400 includes a router 401, a router 402, a router 403, a router 404, and a router 405. In this embodiment, the routers 401 to 405 can correspond to the routers 101 to 105 in FIG. 1, respectively, and the link costs are also the same (refer to the discussion of FIG. 1). The difference between FIG. 4A and FIG. 1 is that the routers 401 to 405 are embodied by the router 300 of the present invention.

Reference is made to FIG. 4B, which is a schematic diagram of the routing table according to an embodiment of the present invention. Taking the router 401 as an example, the routing table records four destinations: 402 to 405. The next-hop router of the router 402 and the router 403 is the router 401 itself, and the routing costs are 2 and 1, respectively. The next-hop routers of the router 404 include the router 402 and the router 403, with routing costs of 3 and 2, respectively. The next-hop routers of the router 405 include the router 402 and the router 403, with routing costs of 4 and 3, respectively.

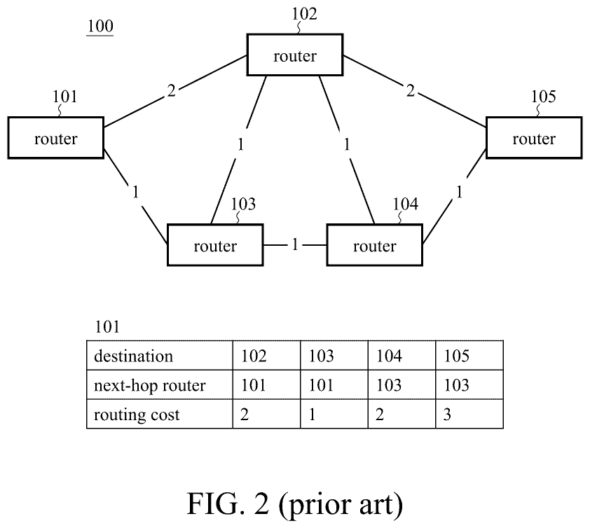

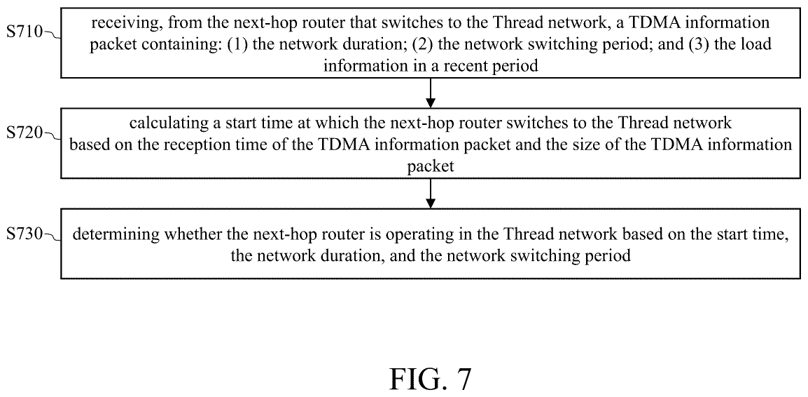

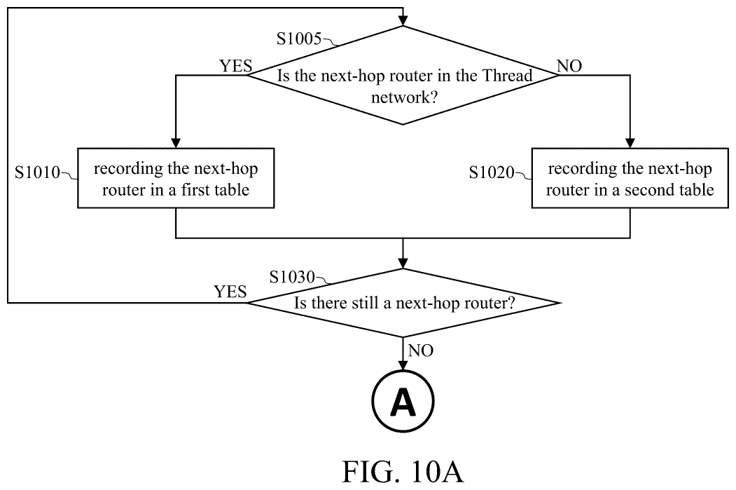

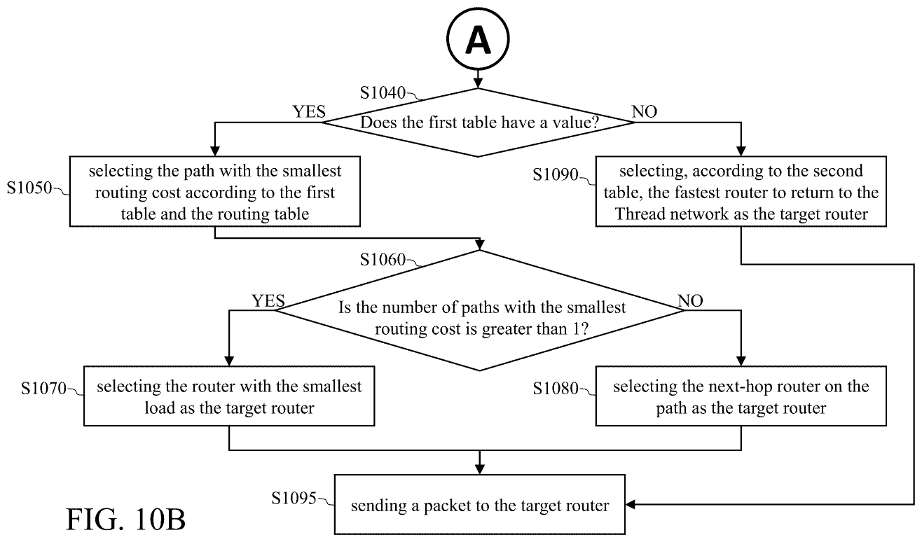

Reference is made to FIG. 2 and FIG. 4B. The difference between the routing table of the present invention and the conventional routing table is that the same destination can correspond to at least N (N>=2) next-hop routers. For example, the router 404 and the router 405 can both correspond to 2 next-hop routers (i.e., N=2). The router 401 can determine the next-hop router according to this routing table. For example, when the destination of a packet sent by the router 401 is the router 404, the router 401 can select the next-hop router 402 or 403 as the target router according to the operation method of the router in FIG. 7 and FIGS. 10A to 10B.

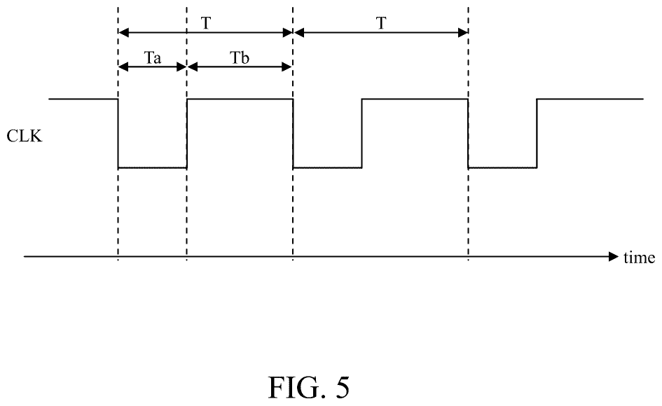

Reference is made to FIG. 5, which shows the waveform of the operating clock of the router 300 according to an embodiment of the present invention. The period of the clock CLK is T. The router 300 operates in the Thread network for a duration Ta (hereinafter referred to as the network duration), while it operates in other networks for a duration Tb. In other words, the period T is the network switching period of the router 300.

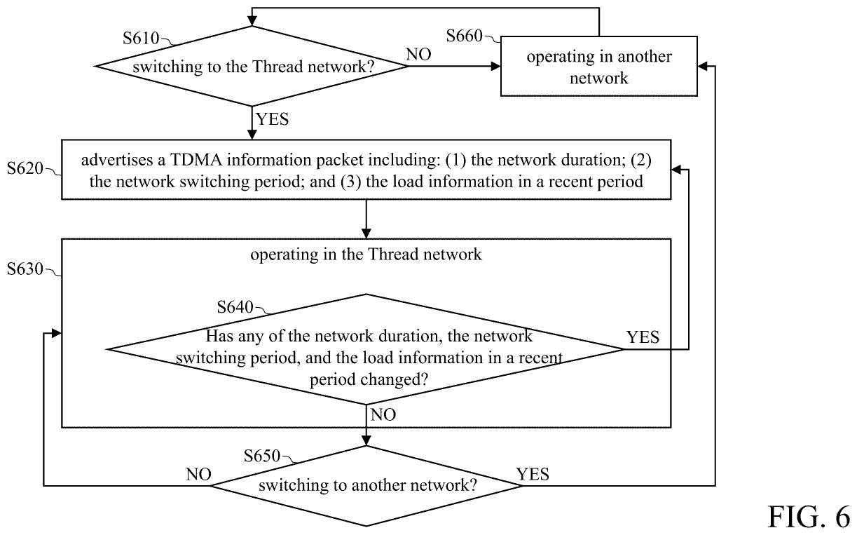

Reference is made to FIG. 6, which is a flowchart of the operation method of a router according to an embodiment of the present invention. The flowchart includes the following steps. The process of FIG. 6 is executed by the control circuit 330 (more specifically, by executing the driver of the wireless transceiver circuit 310).

Step S610: The control circuit 330 of the router 300 determines whether the router 300 switches from another network to the Thread network. If YES, then the flow proceeds to step S620; otherwise, the flow proceeds to step S660.

Step S620: The control circuit 330 advertises a TDMA information packet through the wireless transceiver circuit 310. The TDMA information packet includes the following information: (1) the duration for which the router 300 continuously operates in the Thread network (i.e., the aforementioned network duration); (2) The network switching period of the router 300; and (3) the load information of the router 300 in a recent period (within a preset time, for example, within the previous 1 second).

In some embodiments, the load information can be represented as “0,” “1,” or “2.” “O” represents that the load of the router 300 (e.g., the number of packets to be transmitted) is less than a first threshold (low load). “2” represents that the load of the router 300 is greater than a second threshold (high load). “1” represents that the load of the router 300 is between the first threshold and the second threshold (medium load). The second threshold is greater than the first threshold.

Step S630: The control circuit 330 of the router 300 controls the router 300 to operate in the Thread network, that is, to perform normal operations of the router in the Thread network. Step S630 includes sub-step S640.

Step S640: The control circuit 330 determines whether any of the above information (1) to (3) has changed. If YES, then the flow proceeds to step S620 (i.e., advertising the packet again to notify the neighboring router(s)); otherwise, the flow proceeds to step S650.

Step S650: The control circuit 330 determines whether it is necessary to switch to another network (e.g., based on the clock CLK in FIG. 5). If YES, then the flow proceeds to step S660; otherwise, the flow proceeds to step S630 (i.e., continues operating in the Thread network).

Step S660: The control circuit 330 of the router 300 controls the router 300 to operate in another network, that is, to perform the normal operations of the router in another network.

In some embodiments, the router 300 can periodically advertise a TDMA information packet to correct the time difference between different routers.

Reference is made to FIG. 7, which is a flowchart of the operation method of a router according to another embodiment of the present invention. The flowchart includes the following steps. The process of FIG. 7 is executed by the control circuit 330 (specifically, by executing the driver of the wireless transceiver circuit 310). In the following discussion, it is assumed that the source router and the destination router are the router 401 and the router 404, respectively. Therefore, the next-hop router is the router 402 or the router 403.

Step S710: The control circuit 330 of the router 401 receives a TDMA information packet from the next-hop router that switches to the Thread network (i.e., the router 402 or the router 403). The TDMA information packet contains the aforementioned information (1) to (3) of the next-hop router.

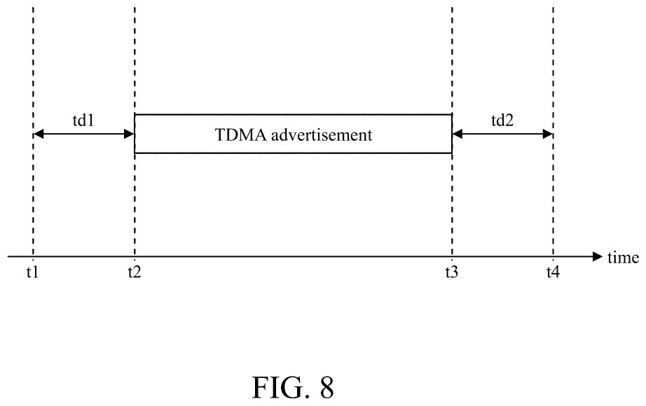

Step S720: Based on the reception time of the TDMA information packet and the size of the TDMA information packet, the control circuit 330 of the router 401 calculates a start time at which the next-hop router switches to the Thread network. Reference is made to FIG. 8, which is a schematic diagram of a router advertising a TDMA information packet according to the present invention. The next-hop router switches to the Thread network at time point t1. The time difference td1 is the preparation time for the next-hop router to perform the TDMA advertisement (i.e., advertising the TDMA information packet). The duration between time point t2 and time point t3 is the length of the TDMA advertisement (i.e., the transmission time of the TDMA information packet). The time difference td2 is the time the router 401 processes the TDMA information packet. The router 401 completes the processing of the TDMA information packet at time point t4 (e.g., obtaining the content of the TDMA information packet). Therefore, the start time t1 is as shown in Equation (1).

$$t 1 = t 4 - td 2 - ( t 3 - t 2 ) - td 1 \qquad ( 1 )$$

where the time difference td1 and the time difference td2 are related to the computing power of the router 300, while the time difference t3−t2 is related to the size of the TDMA information packet and the transmission rate of the router 300. Generally speaking, the time difference td1 and the time difference td2 can be set as fixed values based on experience. In some embodiments, if the router 300 has excellent computing power (e.g., td1<0.01*(t3−t2) and/or td2<0.01*(t3−t2)), then the time difference td1 and/or the time difference td2 can be ignored.

Step S730: The router 401 determines whether the next-hop router is operating in the Thread network based on the start time (t1), the network duration (Ta), and the network switching period (T). For example, suppose the difference between the current time and the start time t1 is T+R (R<T). When R is less than Ta, the next-hop router is operating in the Thread network. When R is greater than or equal to Ta, the next-hop router is operating in another network.

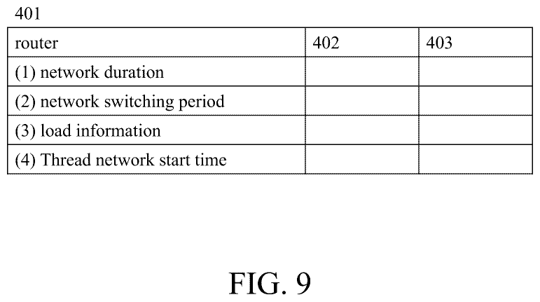

Reference is made to FIG. 9, which is a schematic diagram of the TDMA message table according to an embodiment of the present invention. Reference is made to FIG. 4B and FIG. 9. Because the router 401 is connected to the router 402 and the router 403 (i.e., the router 401 can receive the TDMA advertisement from the router 402 and the router 403), the TDMA message table of the router 401 (as shown in FIG. 9) stores the TDMA messages of the router 402 and the router 403. When the router 401 is about to transmit a packet, the router 401 can determine the target router based on the routing table in FIG. 4B and the TDMA message table in FIG. 9 (the details will be discussed below in connection with FIG. 10A and FIG. 10B). It should be noted that for the four rows of information (1) to (4) in FIG. 9, the router 402 and the router 403 can have the same or different values.

Reference is made to FIG. 10A and FIG. 10B, which are flowcharts of the operation method of a router according to another embodiment of the present invention. The flowchart includes the following steps. Reference is made to FIG. 4B. The following discussion assumes that the source router and the destination router are the router 401 and the router 404, respectively. In other words, the router 401 will determine the target router from its two next-hop routers (the router 402 and the router 403). The processes of FIG. 10A and FIG. 10B are executed by the control circuit 330 of the router 401 (more specifically, by executing the driver of the wireless transceiver circuit 310).

Step S1005: The router 401 determines whether the next-hop router is in the Thread network. The router 401 can determine whether the next-hop router is in the Thread network based on the current time and the TDMA message table in FIG. 9 (refer to the discussion about FIGS. 7 to 9). If YES, then the flow proceeds to step S1010; otherwise, the flow proceeds to step S1020.

In some embodiments, if the next-hop router does not provide the TDMA message (e.g., the next-hop router is not implemented using the router 300), then the router 401 determines in step S1005 that the router is operating in the Thread network (i.e., the result of step S1005 is YES).

Step S1010: The router 401 records the next-hop router in a first table.

Step S1020: The router 401 records the next-hop router in a second table.

Step S1030: The router 401 searches the routing table for the undetermined next-hop router. If there is still a next-hop router (i.e., step S1030 is YES), then the flow proceeds to step S1005; otherwise, the flow proceeds to step S1040.

Reference is made to FIG. 4B. Assuming that the router 402 and the router 403 are both operating in the Thread network, the router 401 sequentially records the router 402 and the router 403 in the first table (step S1010), and then enters the process of FIG. 10B. After the process of FIG. 10A is completed, the first table has values (the content is “402, 403”), while the second table is empty.

Step S1040: The router 401 determines whether the first table has a value. If YES, then the flow proceeds to step S1050; otherwise, the flow proceeds to step S1090.

Step S1050: The router 401 selects the path with the smallest routing cost according to the first table and the routing table. Assuming the content of the first table is “402, 403,” the router 401 selects the path corresponding to the router 403 (because its routing cost is smaller) according to the routing table in FIG. 4B. In another embodiment, if the routing cost of the router 402 is the same as that of the router 403 (i.e., the two values with a gray background in FIG. 4B are the same), the router 401 generates two candidate paths in step S1050.

Step S1060: The router 401 determines whether the number of paths with the smallest routing cost is greater than 1. If YES (indicating that there are multiple candidate paths), then the flow proceeds to step S1070; otherwise (indicating that there is only one candidate path; taking FIG. 4B as an example, the candidate path corresponds to the path of the router 403), the flow proceeds to step S1080.

Step S1070: The router 401 selects the router with the smallest load as the target router, that is, selects the router with the smallest load according to the load information in FIG. 9. A router with a smaller load is less likely to cause network congestion.

Step S1080: The router 401 selects the next-hop router on the path as the target router. For the example of FIG. 4B, because there is only one candidate path, the router 401 selects the next-hop router 403 as the target router.

Step S1090: The router 401 selects, according to the second table, the fastest router to return to the Thread network as the target router. Taking FIG. 4B as an example, when the router 401 performs step S1090, it indicates that neither the router 402 nor the router 403 is operating in the Thread network (i.e., the content of the second table is “402, 403”). Then, the router 401 identifies the fastest router to return to the Thread network as the target router according to the TDMA message table in FIG. 9. For example, assuming that at this time the router 402 and the router 403 will return to the Thread network after 10 ms and 20 ms, respectively, then the router 401 selects the router 402 as the target router (even if the link cost of the router 402 is higher, because this can reduce the probability of network congestion).

Step S1095: After determining the target router, the router 401 sends a packet to the target router.

In summary, because the router of the present invention can know whether the next-hop router is operating in the Thread network, the better target router (e.g., the router operating in the Thread network, or the router that returns to the Thread network more quickly) can be selected to avoid network congestion and interference.

The Thread network is intended to illustrate the invention by way of example and not to limit the scope of the claimed invention. People having ordinary skill in the art may apply the present invention to other types of networks (including, but not limited to, Zigbee and WiFi) in accordance with the foregoing discussions.

Since a person having ordinary skill in the art can appreciate the implementation detail and the modification thereto of the present method invention through the disclosure of the device invention, repeated and redundant description is thus omitted. Note that the shape, size, and ratio of any element in the disclosed figures are exemplary for understanding, not for limiting the scope of this invention. Furthermore, there is no step sequence limitation for the method inventions as long as the execution of each step is applicable. In some instances, the steps can be performed simultaneously or partially simultaneously.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A router, switching between a first network and a second network, comprising:
a wireless transceiver circuit;
a memory configured to store a plurality of program instructions or codes; and
a control circuit coupled to the wireless transceiver circuit and the memory and configured to execute the plurality of program instructions or codes to perform following steps:
advertising a packet including a network duration and a network switching period;
wherein the network duration represents a first duration for which the router continuously operates in the first network, and the network switching period is substantially equal to the first duration plus a second duration for which the router continuously operates in the second network.

2. The router of claim 1, wherein the packet further comprises a piece of load information representing the number of packets to be transmitted by the router within a preset time.

3. The router of claim 1, the control circuit further performs following steps:
advertising the packet when either the network duration or the network switching period changes.

4. The router of claim 1, the control circuit further performs following steps:
controlling, according to a clock, the router to operate in the first network or the second network, wherein a period of the clock is the network switching period.

5. The router of claim 1, wherein the step of advertising the packet is executed when the router switches from the second network to the first network.

6. A method of operating a router switching between a first network and a second network, the method comprising:
advertising a packet including a network duration and a network switching period;
wherein the network duration represents a first duration for which the router continuously operates in the first network, and the network switching period is substantially equal to the first duration plus a second duration for which the router continuously operates in the second network.

7. The method of claim 6, wherein the packet further comprises a piece of load information representing the number of packets to be transmitted by the router within a preset time.

8. The method of claim 6 further comprising:
advertising the packet when either the network duration or the network switching period changes.

9. The method of claim 6 further comprising:
operating in the first network or the second network according to a clock, a period of which is the network switching period.

10. The method of claim 6, wherein the step of advertising the packet is executed when the router switches from the second network to the first network.

11. A method of operating a router, the method being applied to a first router and comprising:
receiving a packet from a second router, wherein the second router switches between a first network and a second network, and the packet includes a network duration and a network switching period;
calculating, based on a reception time of the packet and a size of the packet, a start time at which the second router switches to the first network; and
determining whether the second router is operating in the first network based on the start time, the network duration, and the network switching period.

12. The method of claim 11, wherein the packet is a first packet, and the method further comprises:
recording the second router in a table when the second router is operating in the first network;
determining a target router according to the table and a routing table of the first router; and
transmitting a second packet to the target router.

13. The method of claim 12, wherein the step of determining the target router according to the table and the routing table of the first router comprises:
selecting a path with the smallest routing cost according to the routing table; and
selecting a next-hop router on the path as the target router.

14. The method of claim 12, wherein the packet further comprises a piece of load information, the table comprises at least one next-hop router, and the step of determining the target router according to the table comprises:
selecting, from the at least one next-hop router, a router with the smallest load as the target router based on the piece of load information when the table and the routing table show that the number of paths with the smallest routing cost is greater than one.

15. The method of claim 11, wherein the packet is a first packet, and the method further comprises:
recording the second router in a table when the second router is not operating in the first network;
determining a target router according to the table; and
transmitting a second packet to the target router.

16. The method of claim 15, wherein the table comprises at least one next-hop router, and the step of determining the target router according to the table comprises:
selecting, from the at least one next-hop router, the fastest router to return to the first network as the target router according to the network duration and the network switching period.

17. The method of claim 11, wherein the network duration represents a first duration for which the second router continuously operates in the first network, and the network switching period is substantially equal to the first duration plus a second duration for which the second router continuously operates in the second network.
